(19) United States
(12) Patent Application Publication
(10) Pub. No.: US 2026/0359775 A1
(43) Pub. Date: Nov. 12, 2026

(54) SYSTEM AND METHOD FOR TRACKING AND MONITORING SEAFOOD

(71) Applicant: Seaquyl Supply Chain Services Ltd, Halifax (CA)

(72) Inventor: Brad Cortlandt, Fall River (CA)

(21) Appl. No.: 19/673,177

(22) Filed: May 11, 2026

Related U.S. Application Data
(60) Provisional application No. 63/802,719, filed on May 9, 2025.

(51) Int. Cl. G06Q 10/0833; G06Q 10/087

(52) U.S. Cl. CPC G06Q 10/0833; G06Q 10/0877

(57) ABSTRACT

One variation of a method includes, at a local controller arranged within a trawling vessel: in response to detecting deployment of a fishing net of the trawling vessel and in response to detecting a fuel consumption rate of the trawling vessel falling within a consumption range corresponding to trawling operation, verifying deployment of the fishing net; in response to a geospatial location of the trawling vessel coinciding with an authorized trawling zone, rendering an authorized operational status of the trawling vessel via a user interface; and, for a container, in a set of containers loaded with seafood units of the first species, storing a set of container metadata in a container sensor arranged on the container. This variation of the method also includes: populating a catch record with a species, a total weight, and the geospatial location; and storing the first catch record in a catch record database.

### CROSS-REFERENCE TO RELATED APPLICATIONS

This Application claims the benefit of U.S. Provisional Application No. 63/802,719, filed on 09May 2025, which is incorporated in its entirety by this reference.

### TECHNICAL FIELD

This invention relates generally to the field of seafood tracking and monitoring operations and, more specifically, to a new and useful system and method for tracking and monitoring seafood.

### BRIEF DESCRIPTION OF THE FIGURES

FIGS. 1A and 1B are flowchart representations of a method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method: Catch Validation

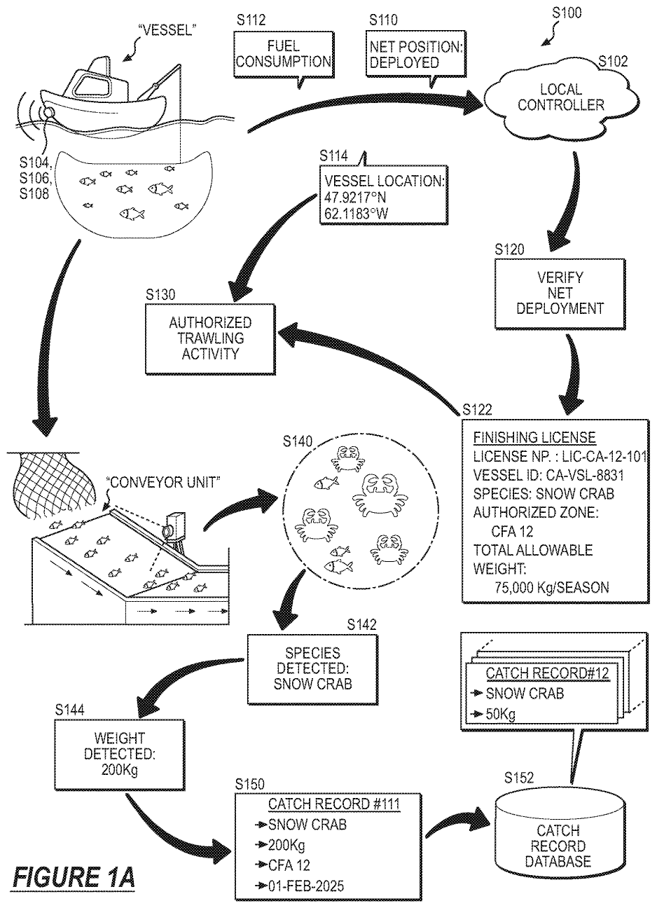

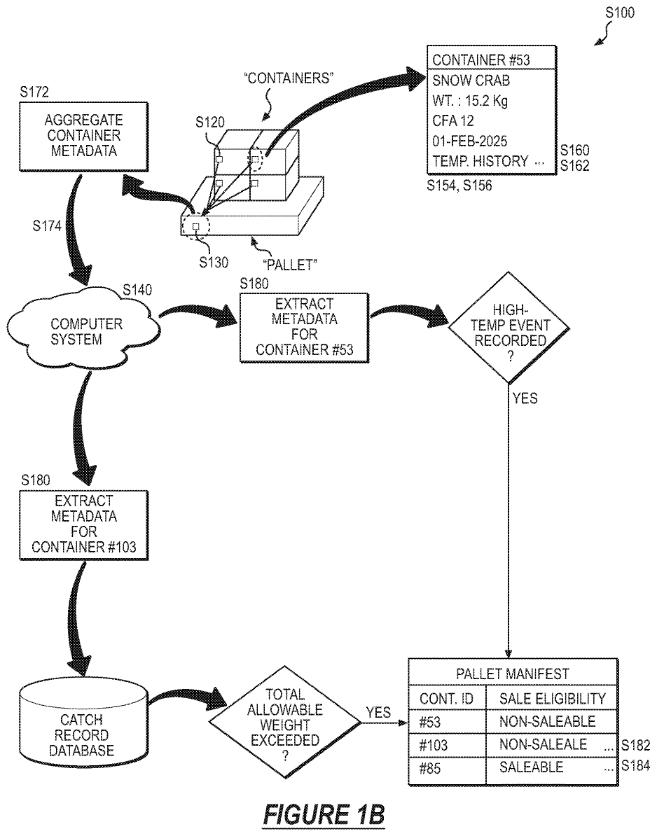

As shown in FIGS. 1A and 1B, a method S100 includes, at a local controller 102 arranged within a trawling vessel: accessing a first signal output by a net deployment sensor 104 arranged within the trawling vessel and indicating a position of a fishing net of the trawling vessel at a first time in Block S110; accessing a second signal output by a fuel sensor 106 arranged within the trawling vessel and representing a fuel consumption rate of the trawling vessel at the first time in Block S112; and, in response to the first signal indicating deployment of the fishing net and in response to the fuel consumption rate falling within a consumption range corresponding to trawling operation, verifying deployment of the fishing net at the first time in Block S120.

The method S100 also includes, at the local controller 102: accessing a third signal output by a locationing sensor 108 and representing a first geospatial location of the trawling vessel at the first time in Block S114; accessing terms of a license associated with the trawling vessel, including an authorized trawling zone for trawling operation in Block S122; and, in response to the first geospatial location of the trawling vessel coinciding with the authorized trawling zone, rendering an authorized operational status of the trawling vessel via a user interface located in the trawling vessel in Block S130.

### 1.1 Method: Catch Characterization

The method S100 further includes, at the local controller 102: accessing a set of images depicting a set of incoming seafood units captured by the trawling vessel at the first time and entering the trawling vessel at a second time succeeding the first time in Block S140; detecting a first species of a first proportion of seafood units, in the set of incoming seafood units, based on the set of images in Block S142; and accessing a first total weight of seafood units in the first proportion of seafood units in Block S144.

The method S100 also includes: initializing a first catch record of the first proportion of seafood units; populating the first catch record with the first species, the first total weight, the first time, and the first geospatial location in Block S150; and storing the first catch record in a catch record database representing species and weights of seafood units captured by the trawling vessel in Block S152.

### 1.2 Method: Container Tagging

One variation of the method S100 includes, at the local controller 102, for each container, in a set of containers loaded with seafood units of the first species: generating a set of container metadata of the container, including a first container identifier of the container, the first species, the first total weight, the first time, and the first geospatial location in Block S154; and storing the set of container metadata in a container sensor 120 arranged on the container in Block S156.

### 1.3 Variation: Container Environmental Tracking

One variation of the method S100 includes, at a first container sensor 120 arranged on a first container in the set of containers: accessing a first signal output by a first temperature sensor arranged within the first container sensor and representing a first temperature of the first container in Block S160; and appending a first set of container metadata of the first container with the first temperature in Block S162.

### 1.4 Variation: Palletized Container Data Aggregation

One variation of the method S100 includes, at a pallet module 130 arranged on a pallet, for each container arranged on the pallet, accessing a set of container metadata of the container in Block S170, the set of container metadata including: a container identifier; a species; a weight of the container; a capture time; a capture location; and a time series of temperatures of the container.

This variation of the method S100 also includes, at the pallet module 130: aggregating a metadata package including each set of container metadata corresponding to a container arranged on the pallet in Block S172; and transmitting the metadata package to a computer system in Block S174.

### 1.5 Variation: Invalid Catch+Non-Saleable Seafood

One variation of the method S100 includes, at a computer system 140: receiving a metadata package corresponding to a pallet in Block S180; initializing a seafood manifest; extracting the first set of container metadata of the first container arranged on the pallet from the metadata package; and identifying a first temperature, in the first set of container metadata, of the first container. This variation of the method S100 also includes, at the computer system, in Block S182, in response to the first temperature exceeding a threshold temperature defined for storage of seafood units, populating the seafood manifest with: the first container identifier of the first container; and a non-saleable status of the first container indicating sale ineligibly of seafood units stored in the first container.

### 1.6 Variation: Valid Catch+Saleable Seafood

One variation of the method S100 includes, at the computer system: extracting the first set of container metadata of the first container arranged on the pallet from the metadata package; and, in response to detecting absence of a temperature, in the first set of container metadata, exceeding a threshold temperature defined for storage of seafood units and in response to the first set of container metadata including the first geospatial location (i.e., the catch location), coinciding with the authorized trawling zone, populating the seafood manifest with the first container identifier of the first container and a saleable status of the first container indicating sale eligibly of seafood units stored in the first container in Block S184.

### 2. Applications

Generally, the method S100 can be executed by a remote computer system (e.g., a remote server, hereinafter a “computer system”) in conjunction with: a suite of onboard sensors and a local controller arranged on a trawling vessel (hereinafter a “vessel”); a population of container sensors, each arranged on a seafood storage container (hereinafter “a container”); and a population of pallet modules, each arranged on a pallet -hereinafter a “seafood monitoring system.”

In particular, the seafood monitoring system can execute Blocks of the method S100: to detect an operational mode (e.g., trawling mode or navigation mode) of the vessel based on signals output by the suite of onboard sensors; to detect a status (e.g., authorized or unauthorized) of trawling activity when the vessel is in a trawling mode, such as based on a geospatial location of the vessel relative to an authorized trawling zone assigned to the vessel; to selectively alert an operator of the vessel in response to detecting unauthorized trawling activity; to detect a species and a weight of seafood units in an incoming catch (i.e., seafood units recently captured by the vessel); to generate and store a catch record, representing the species, estimated weight, time of capture, and geospatial location of the catch, in a catch record database containing a cumulative history of catch events for the vessel; to aggregate a set of container metadata (e.g., species, a container weight, a timestamp of loading, and a catch location) corresponding to a container loaded with seafood units from the incoming catch; and to store the set of container metadata in a container sensor arranged on the container.

### 2.1 Vessel

The seafood monitoring system can be configured for deployment on a vessel, such as a vessel configured to capture, process, and temporarily store seafood units during trawling operations. For example, a vessel may include: a net deployment system (e.g., a hydraulic trawl winch and boom assembly) configured to deploy a fishing net (hereinafter referred to as a “net”) during a trawling operation and retract the net to draw the seafood units (i.e., the incoming catch) into the vessel; and a conveyor unit arranged within the trawling vessel (e.g., below deck) and configured to receive incoming seafood units and transfer these incoming seafood units to containers for temporary storage. In particular, the conveyor unit may traverse these seafood units through a processing area, where the seafood units can be classified, sorted into containers, and weighed. More specifically, each container can include a container sensor associated with a unique container identifier and containing metadata corresponding to the seafood units stored within the container.

### 2.2 Authorized Trawling

The seafood monitoring system can detect a status (e.g., authorized or unauthorized) of trawling activity when the vessel is in a trawling mode to verify that seafood units captured during the trawling operation are compliant with license conditions and eligible for sale or export. In particular, the local controller can detect the vessel in trawling mode based on sensor data representing increased fuel consumption rate consistent with net drag and/or a deployment of the net. The local controller can then: access terms of a license associated with (i.e., issued to) the vessel that specifies an authorized trawling zone, a target species, and a quota limit (e.g., a maximum catch weight); verify that a geospatial location of the vessel coincides with the authorized zone; retrieve cumulative catch weights of previously-recorded trawling operations from a catch record database; and verify that the total recorded catch weight remains within the allowable quota specified in terms of the license. In response to detecting that any condition for authorized trawling activity is not met, the local controller can serve an alert to the operator of the vessel, prompting the operator to execute a corrective action, such as retracting the net or relocating the vessel to remain in compliance with terms of the license conditions. Thus, the local controller can verify compliance of detected trawling activity in real time to: reduce resources allocated to trawling activity that may result in unsaleable catch (e.g., catch exceeding licensed quotas or taken in unauthorized zones); and minimize environmental impact by preventing the unnecessary harvesting of seafood units that are not permitted for retention or sale.

### 2.3 Catch Processing

Generally, during processing of incoming seafood units, a conveyor unit (e.g., on a processing line) arranged within the trawling vessel (e.g., below deck) may: receive incoming seafood units, such as incoming seafood units delivered by a net deployment system (e.g., a hydraulic trawl winch and boom assembly); and traverse seafood units through a processing area, where the incoming seafood units can be classified, sorted into containers, and weighed.

In particular, during processing of incoming seafood units, the local controller can: access images of the incoming catch located on the conveyor unit (e.g., as the conveyor unit traverses the seafood units past an optical sensor); and detect species of seafood units in the incoming catch based on these images. The conveyor unit may then traverse the incoming seafood units to a container loading zone where seafood units may be packed into containers; and transfer containers (i.e., loaded containers) to a weigh station, where each container is weighed.

The local controller can then store a catch record of the incoming catch in a catch record database containing species and weights of seafood units captured by the trawling vessel. Additionally, for each container, in a set of containers loaded with seafood units from the incoming catch, the local controller can: aggregate a set of container metadata of the container, including a container identifier of the container, a species of seafood units stored in the container, the container weight, the catch time, and the catch location; and store the set of container metadata in a container sensor arranged on the container. Alternatively, the local controller can: aggregate the set of container metadata of the container package; and transmit the set of container metadata to the remote computer system.

### 2.4 Seafood Manifest

The seafood monitoring system can also execute Blocks of the method S100: to aggregate a metadata package including container metadata for each container loaded on a pallet via a pallet module on the pallet; to transmit the metadata package, via the pallet module, to the remote computer system; to derive a sale eligibility status (e.g., saleable or non-saleable) for each container, such as based on confirmation of compliance with permitted trawling activity and cold chain integrity protocols; and to generate a seafood manifest representing container metadata and sale eligibility status of each container storing seafood units.

The seafood manifest may then be reviewed by regulatory personnel (e.g., at a dockside inspection area) to confirm eligibility of seafood units for sale or export. For example, for a particular container with a saleable status, regulatory personnel may trigger generation of a verification certificate (e.g., required for entry into domestic or international seafood markets). Alternatively, for a particular container with a non-saleable status, regulatory personnel may flag the container for discard.

### 2.5 Container Monitoring+Manifest Updates

Additionally, the computer system can continuously update the seafood manifest to reflect a current eligibility status of seafood units stored in each container. In particular, the computer system can continuously access container metadata and detect anomalies (e.g., absence of container metadata representing a container temperature), violations of seafood handling protocols, or other conditions affecting seafood quality or eligibility, such as when containers are stored on the vessel, in transit to a cold storage facility, and/or in storage at the cold storage facility. In particular, the computer system can monitor container metadata (e.g., via signals output by the container sensor) for presence of a high-temperature event indicating possible spoilage of seafood units stored in a container. In response to detecting a high-temperature event, the computer system can then update the seafood manifest to reflect a non-saleable status of seafood units stored in the container.

Accordingly, the computer system can generate a comprehensive and verifiable seafood manifest that reflects the traceability, regulatory compliance, and sale eligibility status of each container (e.g., each container loaded on a pallet). Therefore, the seafood monitoring system can: increase inspection and certification efficiency (e.g., at offload or customs checkpoints); prevent unauthorized or noncompliant seafood units from entering the supply chain; and maintain reliable, auditable documentation for each container that complies with audit, customs, and downstream documentation requirements. Additionally, by maintaining verifiable catch and handling records (i.e., from vessel to dock to distribution), the seafood monitoring system can: reduce the volume of seafood discarded at borders due to inadequate or unverifiable documentation, thereby minimizing economic loss and environmental waste throughout the supply chain; and prevent entry of mishandled or spoiled seafood into commercial distribution by identifying containers exposed to improper handling or thermal excursions.

### 3. Terms

A “license” as referred to herein is a fishing license associated with (e.g., issued to) a particular trawling vessel that specifies: an authorized zone in which the vessel is permitted to deploy its fishing equipment; a target species that the vessel is permitted to catch; and a maximum catch weight (or a “Total Allowable Catch (TAC)”) of seafood units of the target species that may be caught during a defined time period.

A “bycatch threshold” as referred to herein is a limit (e.g., a maximum bycatch weight or a percentage) of non-target species that may be retained or encountered by a particular vessel during a trawling operation. In particular, a bycatch threshold can be specified in terms of a license issued to a particular vessel and/or defined by a regulatory entity governing the authorized zone specified for the vessel. In one example, terms of a license specify a per-haul bycatch limit (e.g., “Bycatch of cod must not exceed 5% of the total weight of each haul.”).

### 4. Example

In one example, a Canadian offshore crabbing vessel (i.e., a trawling vessel) is associated with a license that specifies: a maximum weight of 75,000 kilograms of snow crab for a particular fishing season; and an authorized zone, such as Crab Fishing Area (CFA) 12 in the Gulf of St. Lawrence. In this example, during a first time period, the local controller: detects a weight of seafood units of the snow crab species (i.e., the target species) in a first catch of seafood units entering the crabbing vessel; detects a weight of seafood units of an Atlantic cod species (i.e., different from the target species) in the first catch of seafood units; and stores the weight of snow crab and the weight of Atlantic cod caught by the crabbing vessel in a catch record database. In response to the weight of seafood units of an Atlantic cod species exceeding a maximum allowable weight of Atlantic cod permitted per catch (i.e., a bycatch threshold), the local controller serves an alert to an operator indicating that the crabbing vessel exceeded the bycatch threshold and prompting the vessel to relocate at least a threshold distance (e.g., 10 nautical miles) prior to continuing trawling operations.

Then, for each container in a first set of containers loaded with snow crab, the local controller stores a set of container metadata (e.g., the container weight, the snow crab species, a catch time, a catch location) in a container sensor arranged on the container. In this example, the first set of containers are then loaded onto a first pallet for temporary storage (e.g., within a cold storage facility of the crabbing vessel). A first pallet module arranged on the first pallet then aggregates a first metadata package including container metadata corresponding to the first set of containers.

Additionally, during a second time period succeeding the first time period, the local controller: detects absence of a relocation event (i.e., the vessel fails to move in response to the relocation prompt); and detects a snow crab species of seafood units in a second catch of seafood units entering the crabbing vessel. In this example, a second set of containers are then loaded with seafood units (i.e., non-conforming seafood units) from the second catch of seafood units and loaded onto a second pallet for temporary storage. A second pallet module arranged on the second pallet then aggregates a second metadata package including container metadata corresponding to the second set of containers.

Upon offloading of the first pallet and the second pallet from the crabbing vessel (e.g., to an inspection area), the computer system: accesses the first metadata package from the first pallet module; initializes a seafood manifest; and populates the seafood manifest with a saleable status of each container in the first set of containers. Additionally, the computer system: accesses the second metadata package from the second pallet module; and populates the seafood manifest with a non-saleable status of each container in the second set of containers based on the recorded failure to relocate following a bycatch threshold violation. Furthermore, upon clearance of the first set of containers by regulatory personnel, each entry, corresponding to a container in the first set of containers, in the seafood manifest may be integrated into an inventory management system for end-to-end traceability (e.g., from vessel to dock to distribution) of each container.

### 5. Seafood Monitoring System

The seafood monitoring system can include a suite of onboard sensors arranged within the vessel, such as: a set of optical sensors (e.g., cameras) configured to capture images depicting incoming seafood units located on the conveyor as the conveyor traverses these incoming seafood units past the set of optical sensors; a net deployment sensor configured to output signals indicating the position (e.g., status) of the net (i.e., deployed or retracted); a locationing sensor (e.g., a GPS module) configured to output signals representing a geospatial location of the trawling vessel; a fuel sensor configured to output signals representing a time series of fuel consumption rates of the trawling vessel; and/or a weight sensor arranged on the conveyor unit and configured to output signals representing weights of containers loaded with seafood units.

In one variation, the suite of onboard sensors can include a trawling module: arranged on the net; and configured to output signals representing environmental conditions proximal the net, such as a water temperature and/or a depth of the net. In particular, the trawling module can include a moisture sensor configured to output signals representing a moisture level proximal the trawling module. In response to detecting a first moisture level exceeding a threshold level (i.e., indicating the trawling module is submerged), the trawling module can record time series water temperatures and/or depths of the net. Then, in response to detecting a second moisture level falling below the threshold level (i.e., indicating the trawling module is dry and/or the net is retracted), the trawling module can broadcast the time series water temperatures and/or depths of the net.

The seafood monitoring system can further include a population of container sensors, each container sensor arranged on a particular container in a population of containers configured to store seafood units. In particular, each container sensor can include: a temperature sensor configured to record temperatures within the container (i.e., temperatures of the seafood units stored in the container); a battery; and a wireless transmitter.

The seafood monitoring system can further include a local controller arranged within the vessel and configured to: interpret signals output by the suite of onboard sensors; and selectively trigger alerts based on these signals.

The seafood monitoring system can further include a population of pallet modules, each pallet module arranged on a particular pallet and configured to access container metadata from each container loaded on the pallet. For example, a pallet module can: query a set of container sensors, corresponding to containers loaded on the pallet, for container metadata, such as on a particular interval; and receive a set of container metadata from a particular container responsive to the query. Alternatively, the pallet module can receive a set of container metadata broadcast by a particular container.

### 6. Net Deployment Validation: Net Retracted

Generally, the local controller can: interpret or verify a position (e.g., deployed or retracted) of the net based on data output by the suite of onboard sensors; and selectively generate alerts and/or display status indicators (e.g., “net deployed,” “unauthorized trawling activity,” or “sensor discrepancy detected”) via an onboard user interface. In particular, the local controller can: access a first target fuel consumption rate range corresponding to navigation operation (i.e., when the vessel is in transit without the net deployed); and access a second target fuel consumption rate range (e.g., 20-60% greater than a first target fuel consumption rate range) corresponding to trawling operation (i.e., when the vessel is actively towing the net and experiencing increased hydrodynamic drag). Alternatively, the local controller can: access a time series of fuel consumption rate values of the vessel; detect a step increase (e.g., a “spike” or a significant upward deviation) in the time series of fuel consumption rate values; and interpret trawling operation of the vessel based on the step increase.

In one implementation, the local controller can: access a first signal output by the net deployment sensor and representing the net in the retracted configuration; and access a second signal output by the fuel sensor and representing a fuel consumption rate of the vessel within a consumption range corresponding to navigation operation. Additionally or alternatively, the local controller can further detect absence of a signal output by the trawling module (i.e., indicating that the trawling module is not submerged, and the net retracted). In response to the first signal, the second signal, and/or the third signal indicating that the net is retracted (and the vessel is in navigation mode), the local controller can: verify the retracted position of the fishing net; and, via the user interface, render a status indicating the retracted position of the net and the navigation mode of the vessel.

### 7. Net Deployment Validation: Net Deployed

In one implementation, the local controller can: access a first signal output by the net deployment sensor and representing the net in the deployed configuration; and access a second signal output by the fuel sensor and representing a fuel consumption rate of the vessel within a consumption range corresponding to trawling operation. Additionally or alternatively, the local controller can further access a third signal output by the trawling module and representing environmental conditions proximal the net. In response to the first signal, the second signal, and/or the third signal indicating that the net is in deployment (and the vessel is in trawling mode), the local controller can: verify deployment of the fishing net; and, via the user interface, render a status indicating deployment of the net and the trawling mode of the vessel.

In another implementation, in response to detecting the vessel in trawling mode, the local controller can: access a fourth signal output by the locationing sensor and representing a geospatial location of the vessel; and access terms of the license associated with the vessel and specifying an authorized zone for trawling operations. In response to detecting the geospatial location of the vessel diverging from the authorized zone, the local controller can serve an alert to the operator (e.g., via the user interface) indicating that the vessel is operating within an unauthorized zone and prompting the operator to relocate the vessel to the authorized zone. Alternatively, in response to detecting the geospatial location of the vessel within the authorized zone, the local controller can: access a total catch weight of seafood units of the target species previously caught by the vessel; and, in response to the total catch weight falling below the maximum catch weight specified in terms of the license associated with the vessel, render a status (e.g., via the user interface) indicating authorized trawling activity within the authorized zone. Alternatively, in response to the total catch weight exceeding the maximum catch weight specified in terms of the license, the local controller can serve an alert to the operator (e.g., via the user interface) indicating unauthorized trawling activity and prompting the operator to retract the net.

Accordingly, the local controller can: verify a position of the net (e.g., retracted or deployed) based on sensor data output by the suite of onboard sensors; infer an operational mode (e.g., trawling mode or navigation mode) of the vessel; detect authorized or unauthorized trawling activity based on the operational mode, geospatial location, and license-defined conditions (e.g., zone, species, quota); and selectively alert the operator in response to detecting unauthorized activity, discrepancies between sensor inputs, or approaching regulatory limits (e.g., catch thresholds or bycatch violations). Thus, the local controller can increase operational efficiency of the vessel and verify compliance (e.g., with local regulations) of trawling activity to: reduce resources (e.g., time and/or fuel) allocated to trawling activity that may result in unsaleable catch (e.g., catch exceeding licensed quotas or taken in unauthorized zones); and minimize environmental impact by preventing the unnecessary harvesting of seafood units that are not permitted for retention or sale.

### 7.1 Variation: Bycatch Threshold

In one variation, the local controller can monitor compliance with a bycatch threshold defined in terms of the license (or applicable regulations). In one example, in response to detecting the geospatial location of the vessel within the authorized zone, the local controller can: access a threshold bycatch weight specified in terms of the license associated with the vessel; and access a total bycatch weight of seafood units of non-target species previously caught by the vessel from the catch record database. In response to the total bycatch weight exceeding the threshold bycatch weight, the local controller can serve an alert to the operator (e.g., via the user interface) indicating unauthorized trawling activity and prompting the operator to retract the net. Thus, in this variation, the local controller can enforce bycatch-related restrictions by comparing cumulative bycatch volume against the permitted threshold and alerting the operator when the threshold is exceeded.

### 8. Net Deployment Validation: Sensor Discrepancies

In one variation, the local controller can: detect discrepancies between sensor data (e.g., indicating possible tampering, sensor misalignment, or reporting inconsistency); and prompt an operator to resolve the detected discrepancy. For example, the local controller can: access a first signal output by the net deployment sensor and representing the net in the retracted configuration; and access a second signal output by the fuel sensor and representing a fuel consumption rate of the vessel within a consumption range corresponding to trawling operation (i.e., rather than navigation operation). In response to detecting a discrepancy between the first signal representing the net in the retracted configuration (i.e., indicating the vessel is in navigation mode) and the second signal representing the fuel consumption rate within the consumption range corresponding to trawling operation (i.e., indicating the vessel is in trawling mode), the local controller can serve an alert to the operator (e.g., via the user interface) indicating a discrepancy between net deployment status and fuel consumption rate data, and prompting the operator to investigate a possible sensor malfunction. Thus, the local controller can corroborate sensor data to detect anomalies, prevent false inferences of trawling activity, and/or deter tampering with the suite of onboard sensors. For example, the local controller can block or restrict further trawling operations (e.g., by issuing a warning) if the vessel exceeds a bycatch threshold.

### 9. Normalizing Fuel Consumption Rate for Environmental Conditions

In one variation, the local controller can normalize the fuel consumption rate of the vessel to account for environmental factors experienced by the vessel that may increase fuel consumption rate (i.e., independently of net deployment), such as: water currents (e.g., opposing currents) that require greater engine power to maintain vessel heading or speed; and/or wind (e.g., headwinds that increase resistance and fuel demand). In this variation, the local controller can: access an actual fuel consumption rate of the vessel during a particular time window; access water current data recorded (e.g., by a current sensor or an onboard navigation system) during the time window; access wind data recorded (e.g., by a wind sensor) during the time window; and access vessel speed and heading data recorded (e.g., by a GPS or an onboard navigation system) during the time window. The local controller can then calculate a normalized fuel consumption rate of the vessel during the particular time window based on the water current data, wind data, and vessel speed and heading data. Additionally, the local controller can implement methods and techniques described above to infer a position (e.g., deployed or retracted) of the net based on the normalized fuel consumption rate. Thus, the local controller can prevent misclassification of net deployment status based on fuel consumption rate anomalies that may result from environmental drag.

### 10. Species Detection+Catch Record Database

In one implementation, the local controller can: access images of an incoming catch located on the processing line (e.g., as seafood units traverse a conveyor positioned below an optical sensor); detect species of seafood units in the incoming catch based on these images; and store catch records in a catch record database containing species and weights of seafood units captured by the trawling vessel. For example, the local controller can implement template matching techniques to classify individual seafood units or groups of seafood units based on correlations between visual features of these seafood units and visual features of known species types. Additionally or alternatively, the local controller can implement a species detection model configured to: ingest images of the incoming catch; and output species classifications for each detected seafood unit or group of seafood units.

The local controller can then derive or estimate a catch composition of the incoming catch. For example, the local controller can: detect a first species corresponding to a first proportion of seafood units, in the set of incoming seafood units, the first species corresponding to the target species specified in terms of the license; detect a first total weight of seafood units in the first proportion of seafood units; initialize a first catch record of the first proportion of seafood units; populate the first catch record with the first species, the first total weight, a time of capture, and a location of capture; and store the first catch record in the catch record database associated with the trawling vessel.

Additionally, the local controller can: detect a second species corresponding to a second proportion of seafood units, in the set of incoming seafood units, the second species corresponding to a non-target species (i.e., bycatch); and implement methods and techniques described above to store a second catch record of the second proportion of seafood units in the catch record database. The local controller can then implement methods and techniques described above to reference the catch record database (i.e., during later trawling operations), such as to flag incoming seafood units captured by the trawling vessel that fail to comply with terms of the license. Thus, the local controller can automatically classify and log seafood units of target species and bycatch species in real-time to maintain a cumulative record of catch history.

### 11. Container Loading+Container Metadata Aggregation

Generally, as shown in FIGS. 1A and 1B, during processing of incoming seafood units, the conveyor unit may: traverse seafood units through a processing area and deliver seafood units to a container loading zone where seafood units may be packed into containers; transfer containers (i.e., loaded containers) to a weigh station; and transfer containers to a loading station for loading onto pallets.

In one implementation, the local controller can: aggregate a set of container metadata corresponding to a particular container, such as data recorded during processing; and associate the set of container metadata with the container. In particular, for a first container loaded with seafood units of a target species, the local controller can: access a first signal output by a weight sensor (e.g., located at a weigh station) representing a weight of the container; and access a second signal output by the container sensor and representing a temperature within the container (i.e., the temperature of seafood units loaded in the container).

The local controller can then aggregate a set of container data including: a container identifier of the container; the species of the seafood units; a timestamp corresponding to a catch, such as a time of net deployment or a time associated with image-based species detection; a catch location representing the geospatial position of the vessel at the time of capture; the loaded container weight of the container; a time series of temperatures of the container; a vessel identifier (e.g., a vessel name, registration number); and/or a license identifier (e.g., a license number). The local controller can then store the set of container metadata in the container sensor arranged on the container. The container may then be loaded onto a pallet, such as a pallet containing a set of containers loaded with seafood units of the target species. Thus, each container can be configured to store traceability data for independent monitoring and downstream inspection of the container, as discussed in detail below.

In one implementation, the pallet module arranged on the pallet can, for each container in the set of containers loaded on the pallet: access the set of metadata corresponding to the container; and extract the loaded container weight of the container from the set of metadata. The pallet module can then calculate a total expected pallet weight of the pallet based on a sum of the loaded container weights of each container arranged on the pallet.

Additionally, the pallet module can: aggregate a metadata package including each set of container metadata corresponding to a container arranged on the pallet; and transmit the metadata package to a computer system. Thus, the pallet module can aggregate and represent the collective metadata of all containers loaded onto the pallet to generate a comprehensive record of the contents of the pallet for monitoring and downstream inspection of the containers, as discussed in detail below.

### 12. Pallet Offloading+Seafood Manifest

Generally, for a set of incoming seafood containers, the computer system can generate a seafood manifest representing: container metadata (e.g., species, weights, catch location, temperature history) of the containers; and a sales eligibility status (or “eligibility status”) of each container. In particular, upon completion of a trawling operation, the vessel may navigate to a dock for offloading and inspection of seafood units caught by the vessel. More specifically, at the dock, a set of pallets (i.e., loaded with containers) may be offloaded from the vessel and inspected by regulatory or customs personnel for compliance with catch documentation requirements, license terms, and/or cold chain integrity protocols.

In one implementation, for a particular set of containers offloaded from the vessel, the computer system can: access a metadata package corresponding to the set of seafood containers; and initialize a seafood manifest corresponding to the set of containers. The computer system can then, for each container: extract a set of container metadata corresponding to the container from the metadata package; derive an eligibility status of the container based on the set of container metadata; and populate the seafood manifest with the container identifier and the eligibility status of the container (e.g., adjacent the container identifier). In particular, for a particular container, the computer system can identify a saleable status of the container in response to: the total expected pallet weight corresponding to an actual pallet weight (e.g., measured on the dock via a forklift equipped with a weight sensor); the set of container metadata confirming compliance with permitted trawling activity specified in terms of the license; and the set of container metadata confirming compliance with cold chain integrity protocols (e.g., absence of a high-temperature event). The computer system can then repeat this process (e.g., for each container arranged on an incoming pallet) to generate the seafood manifest representing the eligibility status of each container.

In one example, regulatory personnel may then review the seafood manifest to verify the seafood manifest and confirm eligibility of seafood units for sale or export. For example, for a particular container with a saleable status, regulatory personnel may trigger generation of a verification certificate (e.g., required for entry into domestic or international seafood markets). Alternatively, for a particular container with a non-saleable status, regulatory personnel may flag the container for discard. Thus, the computer system can generate a comprehensive and verifiable seafood manifest that reflects the traceability, regulatory compliance, and sale eligibility status of each incoming seafood container, thereby increasing inspection efficiency, preventing unauthorized or noncompliant seafood units from entering the supply chain, and complying with audit, customs, and downstream documentation requirements.

### 13. Continuous Eligibility Monitoring

In one variation, the computer system can continuously update the seafood manifest to reflect a current eligibility status of seafood units stored in each container. In particular, the computer system can continuously access container metadata and detect anomalies (e.g., absence of container metadata representing a container temperature), violations of seafood handling protocols, or other conditions affecting seafood quality or eligibility, such as when containers are stored on the vessel, in transit to a cold storage facility, and/or in storage at the cold storage facility.

In one example, the computer system can: access a set of container metadata corresponding to a container; and, in response to a first temperature (e.g., recorded while the container was in transit to a cold storage facility), in the set of container metadata, exceeding a threshold temperature defined for storage of seafood units, flag the container for discard in the seafood manifest. In another example, in response to absence of a signal from the container sensor at a first time, the computer system can query the container sensor for a first temperature of the container at the first time. In response to absence of a signal from the container responsive to the query, the computer system can flag the container for discard in the seafood manifest. Thus, the computer system can maintain quality assurance throughout the post-catch supply chain (e.g., from storage on the vessel to sale to a consumer) by flagging containers that encounter unacceptable conditions and/or lack verifiable data required to support sale eligibility and traceability.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
at a local controller arranged within a trawling vessel:
accessing a first signal output by a net deployment sensor arranged within the trawling vessel and indicating a position of a fishing net of the trawling vessel at a first time;
accessing a second signal output by a fuel sensor arranged within the trawling vessel and representing a fuel consumption rate of the trawling vessel at the first time;
in response to the first signal indicating deployment of the fishing net and in response to the fuel consumption rate falling within a consumption range corresponding to trawling operation, verifying deployment of the fishing net at the first time;
accessing a third signal output by a locationing sensor and representing a first geospatial location of the trawling vessel at the first time;
accessing terms of a license associated with the trawling vessel, including an authorized trawling zone for trawling operation;
in response to the first geospatial location of the trawling vessel coinciding with the authorized trawling zone, rendering an authorized operational status of the trawling vessel via a user interface located in the trawling vessel;
accessing a set of images depicting a set of incoming seafood units captured by the trawling vessel at the first time and entering the trawling vessel at a second time succeeding the first time;
detecting a first species of a first proportion of seafood units, in the set of incoming seafood units, based on the set of images;
accessing a first total weight of seafood units in the first proportion of seafood units; and
for a first container, in a set of containers loaded with seafood units of the first species:
generating a first set of container metadata of the first container, including a first container identifier of the first container, the first species, the first total weight, the first time, and the first geospatial location; and
storing the first set of container metadata in a first container sensor arranged on the first container;
initializing a first catch record of the first proportion of seafood units;
populating the first catch record with the first species, the first total weight, the first time, and the first geospatial location; and
storing the first catch record in a catch record database representing species and weights of seafood units captured by the trawling vessel.

2. The method of claim 1, further comprising:
at the first container sensor arranged on the first container:
accessing a signal output by a first temperature sensor arranged within the first container sensor and representing a first temperature of the first container; and
appending a first set of container metadata of the first container with the first temperature.

3. The method of claim 1, further comprising:
at a pallet module arranged on a pallet, for each container arranged on the pallet, accessing a set of container metadata of the container including:
a container identifier;
a species;
a weight of the container;
a capture time; a capture location; and
a time series of temperatures of the container.

4. The method of claim 3, further comprising:
at the pallet module:
aggregating a metadata package including each set of container metadata corresponding to a container arranged on the pallet; and
transmitting the metadata package to a computer system.
